(19) United States
(12) Patent Application Publication
(10) Pub. No.: US 2008/0162426 A1
(43) Pub. Date: Jul. 3, 2008

(54) FIND FEATURES

(75) Inventor: Tobias HAUG, Heidelberg (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/617,456

(22) Filed: Dec. 28, 2006

(51) Int. Cl. G06F 17/30

(52) U.S. Cl. 707/3

(57) ABSTRACT

Systems and methods are described that permit a user to search column-specifically using smartkeys. A smartkey identifies a subset of the data in a database, including pre-defined or user-defined short forms or abbreviations. Using these short forms, or smartkeys, the user can interact, define and narrow searching. The parsing strategy may be used to parse user input, which may include smartkeys and search strings, into a parsed form, which may include column identifiers and search strings. A search algorithm may be used to search the columns in a tabular view represented by the column identifiers in a database for those search strings, A configuration interface may be provided to aid in creating and updating the smartkeys.

### BACKGROUND

The present invention provides a computer user interface toot for use in computer applications through which operators may perform context specific searching.

Modern computer applications managing data, such as database applications or spreadsheet applications, typically present the data in a viewable tabular format. The columns of the tabular view are often labeled with a heading of what the data in that column represents. For example, a database containing information on the employees of a company might be represented in a tabular format. Such a table might have a separate column for the employee's identification number, the employee's last name, the employee's first name, and the department in which the employee works. The table headings might respectively be “Personnel ID”, “Last Name”, “First Name” and “Reporting Line Unit”. These computer applications typically provide a search functionality where either the operator is provided with column specific filtering, where the operator may select a specific column and search within that particular column, or the operator is provided with a generic search, where data in all columns are searched.

Several drawbacks may exist. First, column-specific filtering requires the user to search for the appropriate column, select that column, and then perform the search. If a computer pointing device is used to select the column, the operator has to perform the additional task of switching from the pointing device to the keyboard in order to type in the search query. For example, if the operator wished to locate the employee record of someone with the first name of Rose in a table containing information on the employees of a company, the operator, using a computer pointing device, might select the column with the heading “First Name”, switch over from the computer pointing device to the keyboard, and then type in the letters for “Rose” before executing the search. Alternatively, if generic searching is performed, extremely generalized results may be returned, and the list of matches would not be context specific. For example, if the operator again wished to locate the employee record of someone with the first name of Rose in a table containing information on the employees of a company, and used a generic search instead, multiple results may be returned. Some of these results may contain Rose as a first name, some may contain Rose as a last name, and some may even contain Rose as part of a department name. It is thus desirable to create systems and methods for streamlining the searching strategy by creating a solution that is flexible and configurable,

### BRIEF DESCRIPTION OF THE DRAWINGS

FIG. 1 shows a block diagram of an exemplary system of the present invention.

FIG. 2a shows an exemplary interface of the present invention.

FIG. 2b shows an exemplary interface of the present invention.

FIG. 2c shows an exemplary interface of the present invention.

FIG. 3 shows a flowchart of illustrative steps of an exemplary method of the present invention.

### DETAILED DESCRIPTION

Systems and methods are described that permit a user to search column-specifically using smartkeys. A smartkey is anything that identifies a subset of the data in a database, including pre-defined or user-defined short: forms or abbreviations. Examples of smartkeys may include “DOB”, “Date of Birth”“6”, “XYZ123”, “3D71 or “®”. “DOB” may represent a short form of “Date of Birth”, which may represent the name of a column in a tabular view of data in a database. Using these short forms, or smartkeys, the user can interact, define and narrow searching. For example, in a database containing sales orders with separate columns for the order numbers, customers' first names and customers” last names, the smartkey “ON” may represent “Order Number” and the smartkey “FN” may represent “First Name”

To search for an order number of 15543 in the column titled “Order Number”, the user may type into the search field “ON: 15543”. To search for the firs name of Rose in the column titled “First Name”, the user may type into the search filed “FN: Rose”. It is also possible to create multiplied refining searches. For example, in a database containing information on the employees of a company, to find an employee with the last name “Peters” who works in the “Sales” department, where the smartkey “LN” represents “Last Name” and the smartkey “DP” represents “Department”, the user might type into the search field “LN: Peters, DP: Sales”.

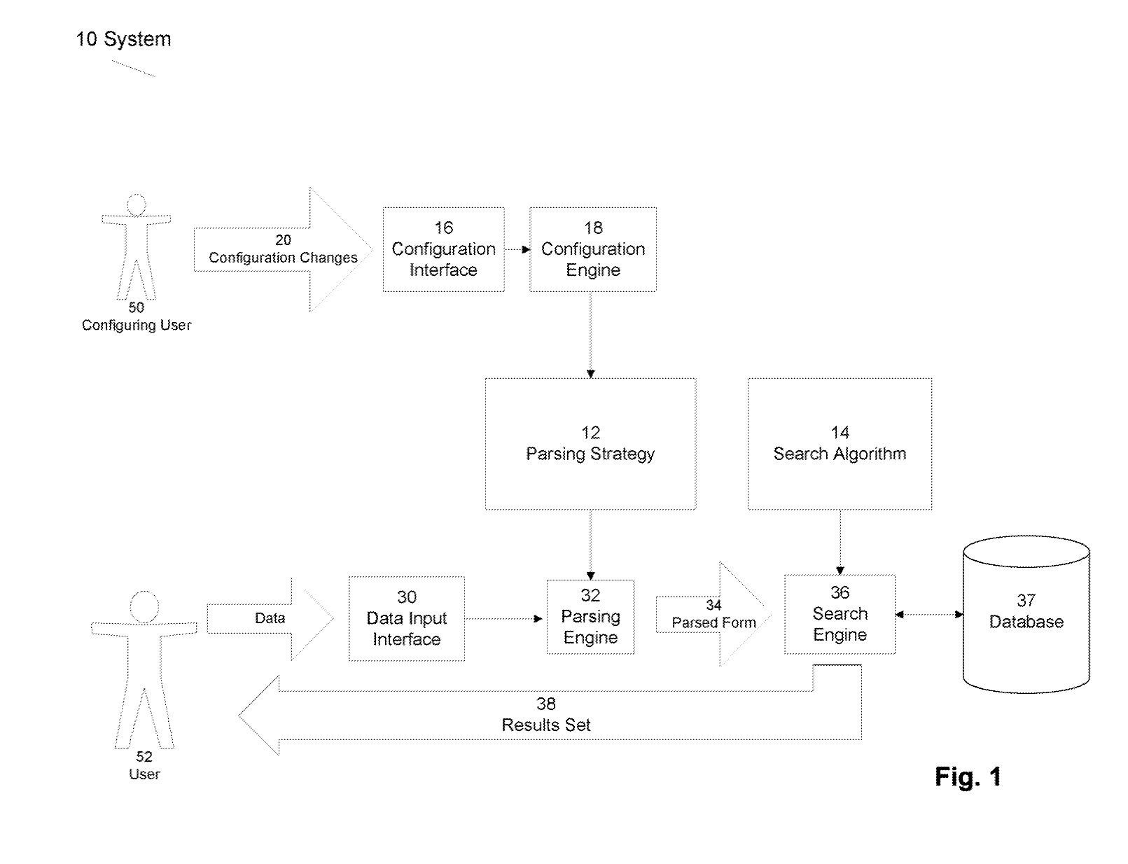

FIG. 1 depicts an exemplary system 10 of the present invention including a parsing strategy 12, a search algorithm 14, a configuration interface 16, a configuration engine 18, a data input interface 30, a parsing engine 32 and a search engine 36. The configuration engine 18 may make changes to the parsing strategy 12 based on configuration changes 20 received from the configuration interface 16. The configuration interface 16 may present an interface that allows the parsing strategy 12 to be altered at run time.

When searching for user input data from input data interface 30, the parsing engine 32 may parse the data according to the parsing strategy 12 into a parsed form 34. The search engine 36 may search a database 37 in accordance with the search algorithm 14 for the user input data based on the parsed form 34. The search engine 36 may collect the results of the search in a results set 38 that may be returned to the user.

By allowing changes to the parsing strategy 12 to be updated at run time, the system may be customized to the particular users who will be entering data. This feature may make user search interfaces more user friendly and compatible with styles of user input in various situations. For example, users of several different applications, where all the separate applications have the customizable smartkeys feature enabled, might wish to search for the first name by using the smartkey “FIN in all instances. Or a user who is accustomed to “FN” representing something other than first name might wish to redefine a pre-defined “FN” smartkey so as to not get confused between first name and another identifier. In this case, the user can redefine the smartkey representing first name to “FirstN” or “NM” or “FName” or any other smartkey the user may wish to define.

Both the parsing strategy 12 and the database 37 may exist as solid state data stores, such as on hard disk, or may be in volatile memory such as RAM memory. Both memory stores may exist as databases of various types, including as relational databases, object oriented databases, flat file databases, or the like. Both memory stores may exist as unitary databases or may be distributed over various database servers. The specific implementation of these memory stores, unless specified, is immaterial to the invention. For illustrative purposes, the parsing strategy memory store 12 is a flat file and the database 37 is a relational database.

Parsing strategy 12 includes the rules used to parse user data. The parsing strategy 12 may include lexical analyzing rules responsible for breaking user input data into tokens. Tokens may be grouped into categories called token types. For example, a lexical rule may exist that breaks an input (such as “ON: 15543”) into “ON”, “:”, and “15543”. Each broken down portion may be designated a token. The tokens may be of [smatrtkey], [separator], and [search string] token types respectively. The tokens may be the actual string literal, and the token types may be the categories to which those string literals belong. The parsing strategy 12 may also include translating rules responsible for mapping [smartkey] tokens to [column identifier] tokens. For example, a translating rule may exist that translates an “ON” token into an “Order Number” token, where “Order Number” corresponds to a column identifier for a column in a tabular view of the data contained in database 37. Database 37 may contain multiple tabular views, each with multiple column identifiers representing the separate columns of any particular tabular view. For example, a tabular view of the information on employees of a company may contain a column with employee first names. This column may have a column identifier of “Employee First Name” which may match the user visible column heading of the column, or it may have a column identifier of “AA,” or Database-XYZ01.Column-BB”, which may not be user visible. A column may have multiple identifiers, of which only one column identifier may be needed to search the contents of that column.

In an embodiment, the parsing rules may be multi-level, such that the parsing engine 32 may make more than one pass to parse the user input. It is thus possible to create multiplied refined searches. The parsing strategy may include multiple lexical analyzing rules, one rule to parse each level of input. For example, to parse a string of multiple smartkey searches (such as “LN: Peters, DP: Sales”), a first rule may parse the user input string into individual smartkey searches by matching a separator, such as ‘,’. Each portion preceding the ‘,’ may be a separate smartkey search. Likewise, the final portion after the ‘,’ may also be a smartkey search, A second rule may parse the smartkey search into tokens of token types [smartkey], [separator], and [search string]. The parsing strategy 12 may also include a translating rule to translate each [smartkey] token into a [column identifier] token.

The parsed form 34 may be a set of tokens derived from the user input data by the parsing engine 32 organized in a logical fashion. The parsed form may be transmitted to the search engine 36 where the parsed form 34 is used in the search algorithm 14 to search for the user input data. For example, referring to the illustration above, the parsed string of multiple smartkey searches may result in a parsed form organized as a set of triplet pairs. Each triplet may correspond to the three portions of an individual smartkey search ([column identifier], [separator], [search string]). Each pair of the triplet may include the token type and the actual token string literal. For example, for the input string “LN: Peters, DP: Sales”, the first triplet may be [column identifier], “Last Name”, [separator], “,”, [search string], “Peters”.

The search algorithm 14 may be a set of rules for searching the database 37 for the parsed form 34. The search engine 36 may incorporate the parsed form 34 into the rules of search algorithm 14 and formulate queries. The search engine 36 may then execute the search queries on the database 37. In one embodiment, the queries may be SQL statements. The rules may be preliminary forms of the SQL statements that include placeholders where the tokens will be inserted. For example, a preliminary SQL statement used to search may be “select * from TABLE where [column identifier]=[search string]”. The search engine 36 may retrieve the first triplet from the parsed form 34 of the above example and replace [column identifier] and [search string] in the SQL preliminary form with the actual, corresponding tokens. Once the replacements have been made, the SQL query may be “select * from TABLE where ‘Last Name’=‘Peters’”. The SQL query may be executed on the database 37. Once the results have been obtained, the search engine 36 may store the results in a temporary table, such as TEMP_TABLE, and move on to the next triplet. For successive triplets, a preliminary SQL statement used to search may be “select * from TEMP_TABLE where [column identifier]=[search string]”. In this way, the results list is further refined through multiplied refined searching. Once the final query has been performed and the results gathered, they may be placed in a results set 38 and returned to the user.

In another example, the SQL statement used to search may be “select * from TABLE where [column identifier]₁=[search string]₁ and [column identifier]₂=[search string]₂ and . . . and [column identifier]_{N-1}=[search string]_{N-1} and [column identifier]_{N}=[search string]_{N}” where [column identifier]₁ and [search string]₁ represents the [column identifier] and [search string] from the first triplet described above, [column identifier]₂ and [search string]₂ represents the [column identifier] and [search string] from the second triplet described above, through [column identifier]_{N} and [search string]_{N}, which represents the [column identifier] and [search string] from the N-th or final triplet described above.

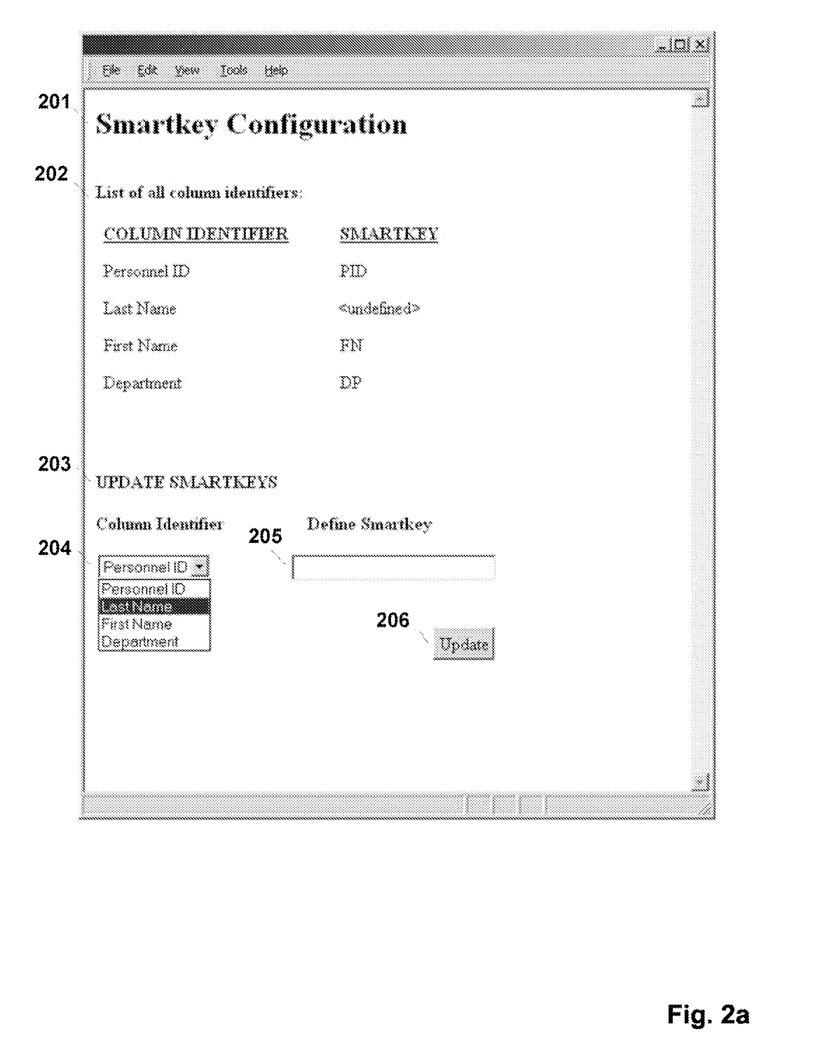

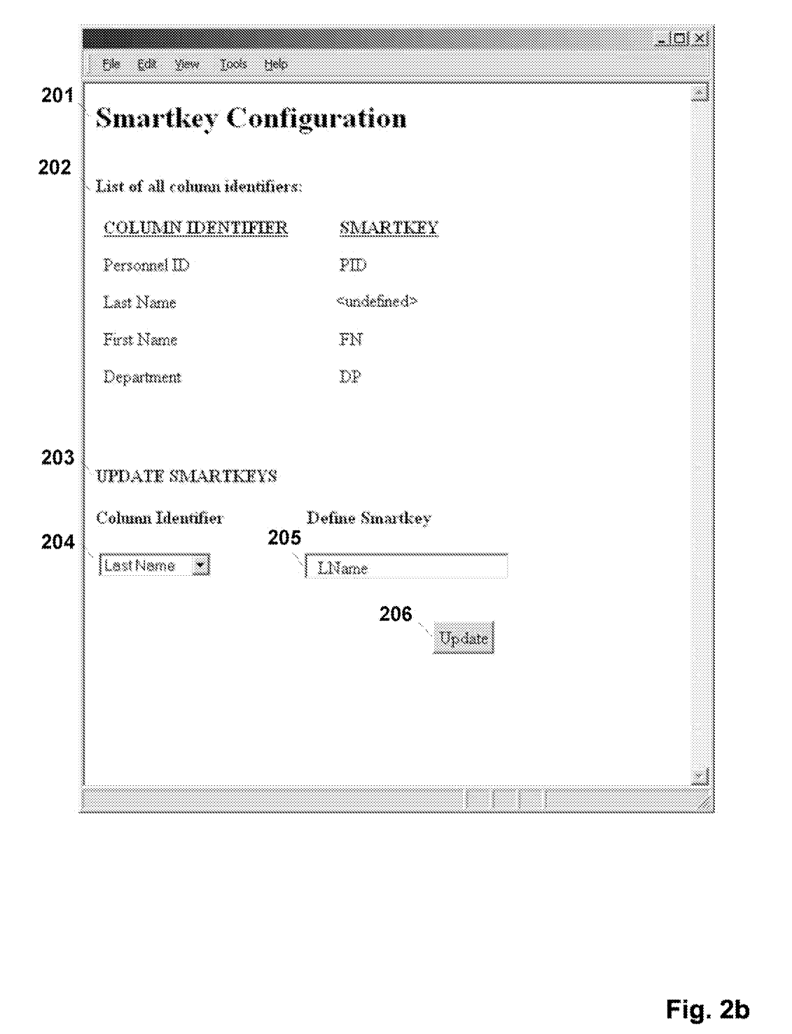

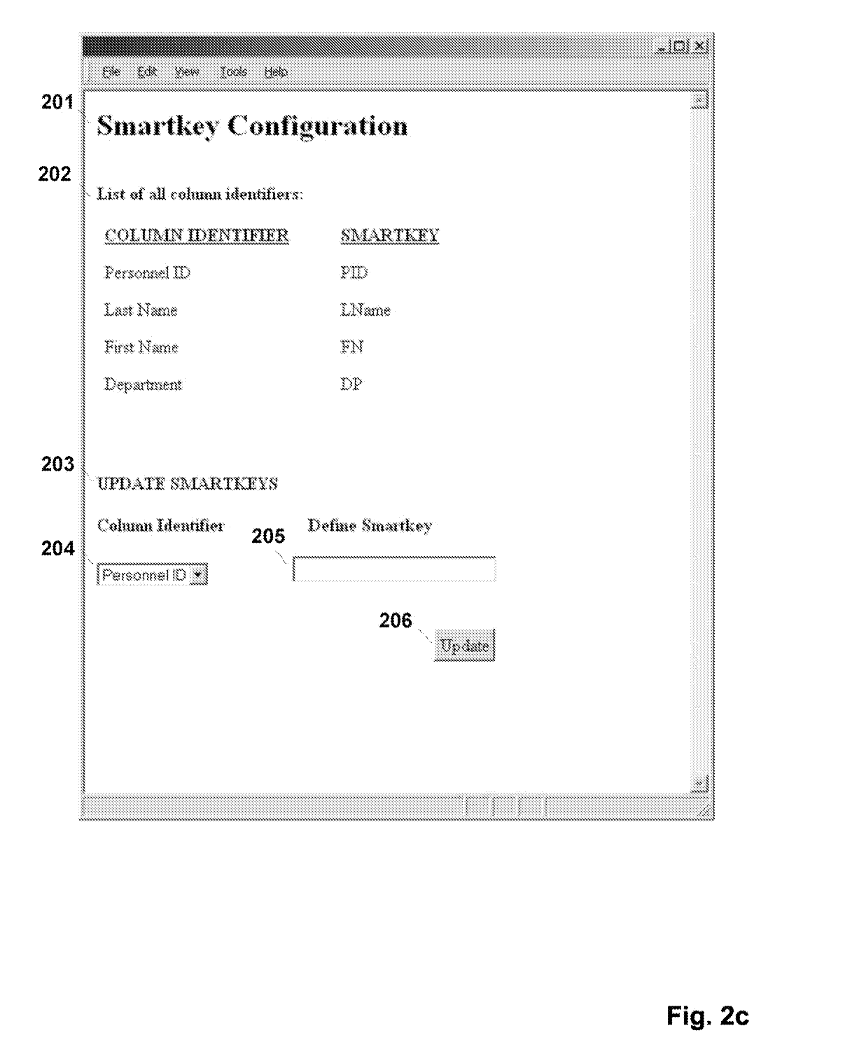

The configuration interface 16 may present an interface to a configuring user to make changes to the parsing strategy 12. In one embodiment, the configuration interface 18 may be implemented as shown in FIGS. 2a, 2b and 2c. FIG. 2a depicts an interface that may permit a configuring user to update the smartkeys. List 202 may contain a list of all column identifiers and the smartkeys (if any) that are currently mapped to those column identifiers. Some or all smartkeys may be predefined. The list is updateable via the Update Smartkeys section 203 on the same configuration screen. Drop down list, 204 may include a list of column identifiers, which the configuring user may select to define a previously undefined column identifier, or redefine a column identifier that is already defined. The configuring user would type into text field 205 the smartkey to correspond to the column identifier selected from drop down list 204. For example, the configuring user may select the column identifier “Last Name” which may be previously undefined and type in “LName” as the name of the smartkey to define (as shown in FIG. 2b). Once the configuring user has selected the parameters for the smartkey, the configuring user may click “Update” button 206 to proceed. The configuration screen may refresh with the updated column identifier and smartkey definitions (as shown in FIG. 2c) and permit further column identifier configurations.

The configuration interface 16 may gather the updates to the smartkeys and send them as configuration changes 20 to the configuration engine 18. Configuration engine 18 may update the parsing strategy 12 to reflect the configuration changes 20. Once the parsing strategy 12 has been updated, the system may process user input data using the updated parsing strategy.

In an embodiment, the parsing strategy may be stored in a configuration file. The configuration file may be read from memory by the configuration engine 18 to incorporate the configuring user changes and written back to memory once the update has been completed. The parsing engine 32 may read the configuration file from memory when invoked. In this way, the system may parse the user input data and search for that data in a manner that reflects the changes made by the configuring user.

In an embodiment, the configuring user, who is responsible for updating the parsing strategy via the configuring interface, and the user who inputs the user input data may be the same person. In this way, a user who uses the system may customize the way that the system may receive input to best suit the user's particular style.

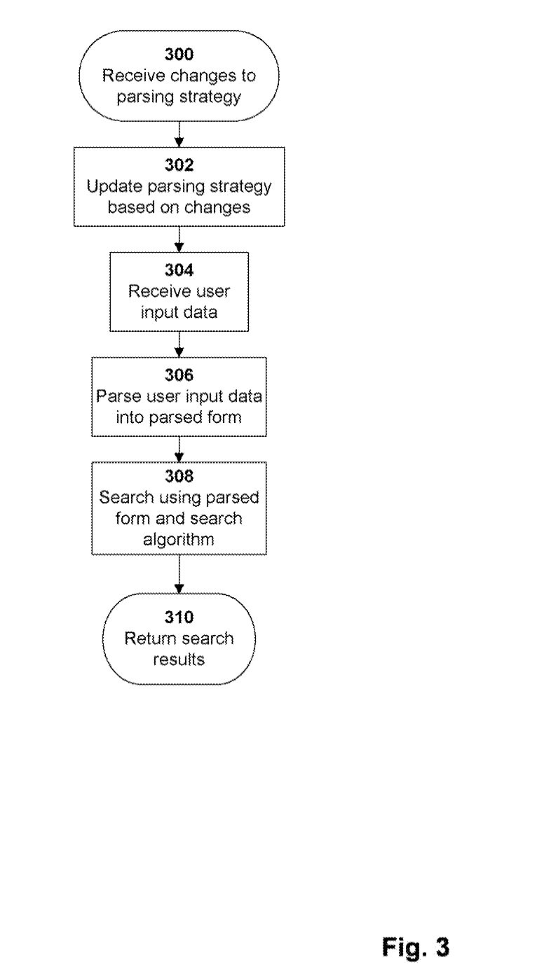

Exemplary steps of the present invention are depicted in FIG. 3. The system may receive changes to a parsing strategy (block 300) from a configuring user. The parsing strategy may initially be configured to map column identifier “Last Name” with smartkey “LN” or column identifier “Last Name” may have no smartkey defined. The configuring user may be presented with a configuration interface (such as that shown in FIGS. 2a, 2b and 2c). The configuration interface may display the column identifiers and the corresponding smartkeys defined. The user may make changes to the parsing strategy, for example, because the potential user may be more familiar with a different smartkey defined from a different application, or simply because of user preference for one with a shorter length, or one more easily recallable. The configuration interface may send the changes to a configuration engine. The configuration engine may update the parsing strategy based on the configuring user changes (block 302). For example, the configuration engine may be operably connected to a file system that includes the parsing strategy configuration file.

The system may receive input data from a user (block 304). The user may input data to the system, querying the system to locate records that match the user input. For example, the user may input “DP=Marketing” desiring to find results that match “Marketing” as the department. A parsing engine may receive the user input data and parse the data (block 306). The parsing engine may attempt to execute certain rules and translate smartkeys into column identifiers and generate a parsed form, A search engine may receive the parsed form and perform a search for the user input data in a database (block 308). The search engine may incorporate the parsed form from the parsing engine into the rules for the search algorithm. The search engine may form queries and execute those queries on the database to locate the desired user input data. The search engine may incorporate the results into a result set and return the result set to the user (block 310).

Several embodiments of the present invention are specifically illustrated and described herein. However, it will be appreciated that modifications and variations of the present invention are covered by the above teachings and within the purview of the claims without departing from the spirit and intended scope of the invention,

What is claimed is:

1. A user interface system comprising,
a data input interface for receiving user input data;
a parsing engine for parsing the user input data based on a parsing strategy and for producing a parsed form therefrom;
the passing strategy comprising rules to translate short forms into column identifiers, and
a search engine for performing a search of a database based on a search algorithm and the parsed form.

2. The system of claim 1, wherein the short forms are pre-defined.

3. The system of claim 1, wherein the short forms are user-defined.

4. The system of claim 1 further comprising.
a configuration interface for receiving changes to the parsing strategy; and
a configuration engine for updating the parsing strategy based on the received changes.

5. The system of claim 4 wherein said configuration interface comprises a text input field for entering changes to the parsing strategy.

6. The system of claim 1, wherein the data input interface is a text entry input field.

7. The system of claim 1, wherein the parsed form comprises a column identifier and a search string, and the search algorithm searches a column in the database represented by the column identifier for the search string.

8. The system of claim 1, wherein the parsed form comprises multiple column identifiers and a multiple search strings, and the search algorithm searches at least one column in the database represented by the column identifiers for the search strings.

9. The system of claim 1, wherein the database is a database in at least one of volatile and nonvolatile memory.

10. The system of claim 1, wherein the database is a database in solid state memory.

11. A user interface method comprising,
providing a parsing strategy;
receiving user input data;
parsing the user input data based on the parsing strategy to produce a parsed form;
searching a database based on a search algorithm and the parsed form to produce search results;
adding the search results to a results set; and
returning the results set,
wherein the providing a parsing strategy and a search algorithm step includes said parsing strategy containing pre-defined short forms.

12. The method of claim 11, wherein said providing a parsing strategy and a search algorithm step includes said parsing strategy containing user-defined short forms.

13. The method of claim 11 further comprising:
receiving changes to said parsing strategy; and
updating said parsing strategy based on said changes.

14. The method of claim 13, wherein said receiving said changes to said parsing strategy step includes receiving said changes from a text entry input field.

15. The method of claim 11, wherein said receiving user input data step includes receiving said user input data from a text entry input field.

16. A user interface method comprising:
providing a parsing strategy;
receiving user input data, where said user input data contains at least one short form and at least one search string;
parsing said user input data based on said parsing strategy to produce a parsed form, where said parsed contains at least one column identifier and said at least one search string;
searching at least one column in a database represented by said at least one column identifier based on a search algorithm for said at least one search string to produce search results;
adding said search results to a results set; and
returning said results set.
